(19) United States
(12) Patent Application Publication
(10) Pub. No.: US 2024/0192973 A1
(43) Pub. Date: Jun. 13, 2024

(54) Artificial Reality Simulation for Augment Manipulation Controls on a Two-Dimensional Interface

(71) Applicant: Meta Platforms Technologies, LLC, Menlo Park, CA (US)

(72) Inventors: Moisés Ferrer SERRA, London (GB); Mykyta LUTSENKO, San Mateo, CA (US); Matthew James GALLOWAY, Berkhamsted (GB); Walter J. LUH, Sunnyvale, CA (US); Christopher LAW, San Francisco, CA (US); Artur KUSHKA, London (GB); Jean-Francois MULE, San Francisco, CA (US); David TEITLEBAUM, Seattle, WA (US); Roman LESHCHINSKIY, London (GB); Dalton Thorn FLANAGAN, New York, NY (US); Dony GEORGE, Sunnyvale, CA (US); David Michael WOODWARD, San Francisco, CA (US)

(73) Assignee: Meta Platforms Technologies, LLC, Menlo Park, CA (US)

(21) Appl. No.: 18/585,911

(22) Filed: Feb. 23, 2024

Related U.S. Application Data
(60) Provisional application No. 63/493,546, filed on Mar. 31, 2023.
(60) Provisional application No. 63/493,550, filed on Mar. 31, 2023.

(51) Int. Cl. G06F 9/451; G06T 19/00

(52) U.S. Cl. CPC G06F 9/451; G06T 19/006

(57) ABSTRACT

In some implementations, the disclosed systems and methods can compute the position of the user interface elements in three-dimensional space, project the position into two-dimensional camera space, and dynamically determine the scale of the user interface elements per frame as either static or dynamic based on the distance between the user and the virtual object. In some implementations, the disclosed systems and methods can simulate a three-dimensional (3D) XR experience on the 2D interface (such as a laptop, mobile phone, tablet, etc.), by placing a virtual XR head-mounted display (HMD) into the XR environment, and providing feeds of the field-of view of the virtual XR HMD to the 2D interface.

### CROSS REFERENCE TO RELATED APPLICATIONS

This application claims priority to U.S. Provisional Application No. 63/493,546, filed Mar. 31, 2023 and to U.S. Provisional Application No. 63/493,550, filed Mar. 31, 2023, both of which are incorporated in their entirety.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset.

Applications can exist that can operate on both XR interfaces and two-dimensional (2D) interfaces. A 2D interface can be a flat surface that can display 2D content, such as objects, graphics, text, etc. For example, a 2D interface can be part of a laptop computer, mobile device, television, etc. On the 2D interface, XR content can be rendered and interacted with differently than on an XR interface due to the limitations of a 2D interface as compared to a fully immersive XR experience.

### SUMMARY

Aspects of the present technology provide contextual modifications and rendering of user interfaces for virtual object manipulation on various 2D or 3D interfaces. Some implementations provide user interface elements for virtual object modification in two dimensions (i.e., without a depth element), in a manner in which they are not occluded by the environment and other augments. Some implementations can compute the position of the user interface elements in three-dimensional space, project the position into two-dimensional camera space, and dynamically determine the scale of the user interface elements per frame as either static or dynamic based on the distance between the user and the virtual object. For rendering, some implementations can render the user interface elements last with transparency on the two-dimensional interface, while other implementations can apply an alpha limit, discarding pixels below a certain transparency threshold.

Additional aspects of the present disclosure are directed to simulation of an artificial reality (XR) environment on a two-dimensional (2D) interface. Some implementations can simulate a three-dimensional (3D) XR experience on the 2D interface (such as a laptop, mobile phone, tablet, etc.), by placing a virtual XR head-mounted display (HMD) into the XR environment, and providing feeds of the field-of view of the virtual XR HMD to the 2D interface. A user of the 2D interface can provide input events to interact with virtual objects in the XR environment (e.g., through a mouse or keyboard) that can be translated into events recognizable by the virtual XR HMD (e.g., head motions, gestures, voice controls, etc.). The translated input events can cause modifications to the XR environment, such as a change in viewpoint, moving about the XR environment, editing the XR environment, etc.

### BRIEF DESCRIPTION OF THE DRAWINGS

FIG. 1A is a wire diagram illustrating a virtual reality headset which can be used in some implementations of the present technology.

FIG. 1B is a wire diagram illustrating a mixed reality headset which can be used in some implementations of the present technology.

FIG. 1C is a wire diagram illustrating controllers which, in some implementations, a user can hold in one or both hands to interact with an artificial reality environment.

FIG. 2 is a block diagram illustrating components which, in some implementations, can be used in a system employing the disclosed technology.

FIG. 3 is a flow diagram illustrating a process used in some implementations of the present technology for providing artificial reality simulation for augment manipulation controls on a two-dimensional interface.

FIG. 4A is a conceptual diagram illustrating an example view on a two-dimensional interface of an artificial reality environment flattened onto the two-dimensional interface with occlusion of user interface elements associated with a virtual object.

FIG. 4B is a conceptual diagram illustrating an example view on a two-dimensional interface of an artificial reality environment flattened onto the two-dimensional interface without occlusion of user interface elements associated with a virtual object.

FIG. 4C is a conceptual diagram illustrating an example view of an artificial reality environment where the user interface elements remain fixed in size.

FIG. 4D is a conceptual diagram illustrating an example view of an artificial reality environment where the user interface elements are scaled according to a position of a user with respect to the virtual object.

FIG. 5 is a block diagram illustrating components which, in some implementations, can be used in a system employing the disclosed technology.

FIG. 6 is a flow diagram illustrating a process used in some implementations of the present technology for simulating an artificial reality environment on a two-dimensional interface.

FIG. 7A is a conceptual diagram illustrating an example view of a two-dimensional interface rendering a simulated artificial reality environment.

FIG. 7B is a conceptual diagram illustrating an example view, from a two-dimensional interface, of interaction options with respect to a virtual object rendered on the two-dimensional interface in a simulated artificial reality environment.

FIG. 7C is a conceptual diagram illustrating an example view, from a two-dimensional interface, of user interface elements providing editing controls for a virtual object rendered on the two-dimensional interface in a simulated artificial reality environment.

FIG. 7D is a conceptual diagram illustrating an example view, from a two-dimensional interface, of a simulated artificial reality environment updated based on selection of an interaction option with respect to a virtual object rendered on the two-dimensional interface.

FIG. 8 is a block diagram illustrating an overview of devices on which some implementations of the present technology can operate.

FIG. 9 is a block diagram illustrating an overview of an environment in which some implementations of the present technology can operate.

The techniques introduced here may be better understood by referring to the following Detailed Description in conjunction with the accompanying drawings, in which like reference numerals indicate identical or functionally similar elements.

### DESCRIPTION

Many users access XR environments through a two-dimensional (2D) interface, such as a mobile phone, tablet, or laptop computer, either to experience the XR environment, or to modify the XR environment. However, it is difficult to translate XR environments to a 2D interface in a way that feels intuitive and natural, as 2D interfaces cannot effectively render a depth element traditionally included in an XR environment. Thus, aspects of the present technology provide XR simulation for virtual object (i.e., “augment”) manipulation controls on a 2D interface. Some implementations provide user interface elements for augment manipulation in two dimensions (i.e., without the depth element), such that the user interface elements are not occluded by the environment and other augments when flattened from an XR environment onto the 2D interface. Some implementations can compute the position of the user interface elements in three-dimensional (3D) space, project the position into 2D camera space, and dynamically determine the scale of the user interface elements per frame. For example, at mid-long distances, some implementations can scale the user interface elements so they have a fixed size on the 2D interface, ensuring that they are accessible. When getting closer, some implementations can lock the scale, such that the user interface elements become larger upon approach. Thus, some implementations can give a user on a 2D interface the sense that the user interface elements are now in world space, instead of camera space. In some cases, a similar augment sizing scheme can be used for users when interacting with augment in a 3D space via an XR interface—where the sizing of augments and/or augment control interfaces are fixed when the augments appear to be outside a threshold distance from the user and are continuously scaled when the augments appear to be inside the threshold distance. For rendering, some implementations can render the user interface elements last with transparency. However, if the user interface elements cannot or are not rendered last, some implementations can apply an alpha limit, discarding pixels of the augment interface below a certain transparency threshold. In other words, applying the alpha limit can act as a switch for each pixel of an augment interface between being fully transparent or fully opaque. To avoid the occlusion of the interface from the environment or other augments, some implementations can project the interface to the virtual camera's near plane. This can preserve the look of the interface by rendering it in front of everything else.

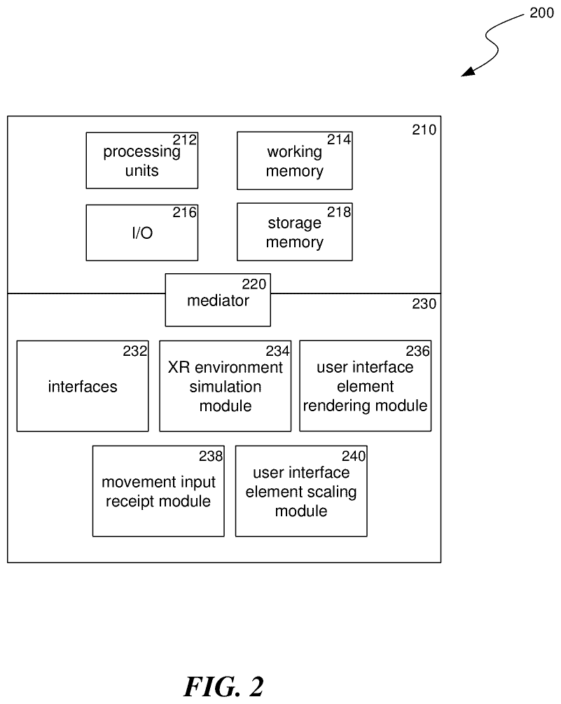

As used herein, an “XR interface” or “3D interface” can be a device capable of displaying a fully immersive XR environment, such as a head-mounted display within an XR system. In some implementations, the XR system can include devices and components other than the XR interface to support the XR experience, such as processing components, input/output devices (e.g., controllers), etc. Such components are described further herein with respect to FIGS. 2A-2C.

A “2D interface” can be an application or device that can render an XR environment on a 2D surface. For example, a 2D interface can be a computer screen, television display, mobile device (e.g., cellular phone), mobile application, web browser, etc. In some implementations, the 2D interface can be part of a 2D system including other devices and components, such as processing components, input/output devices, etc.

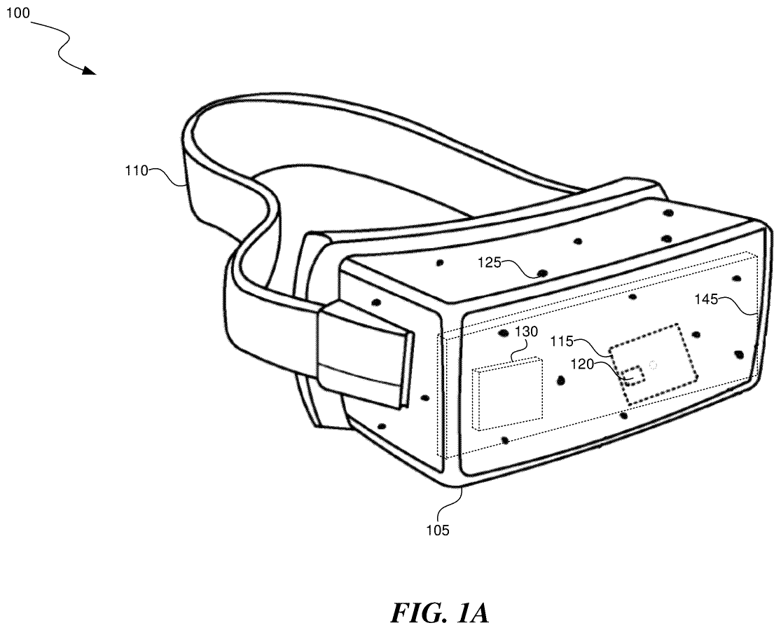

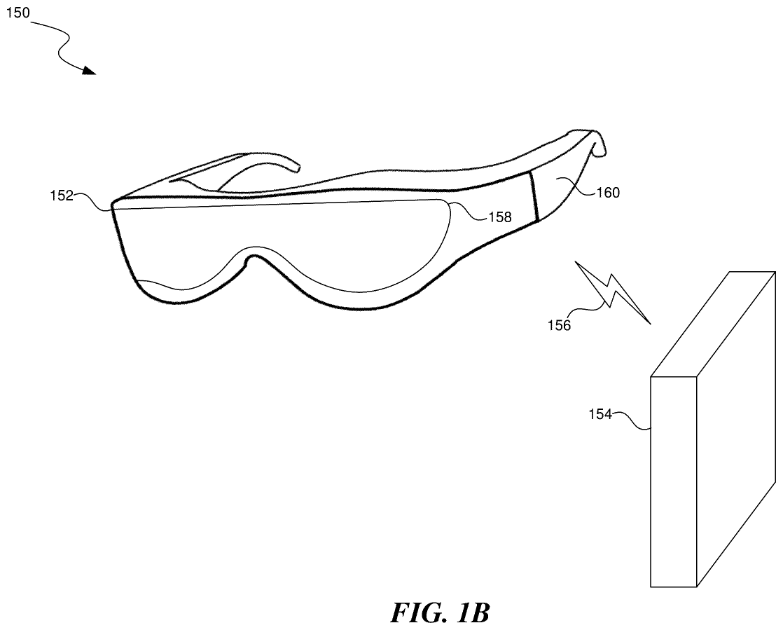

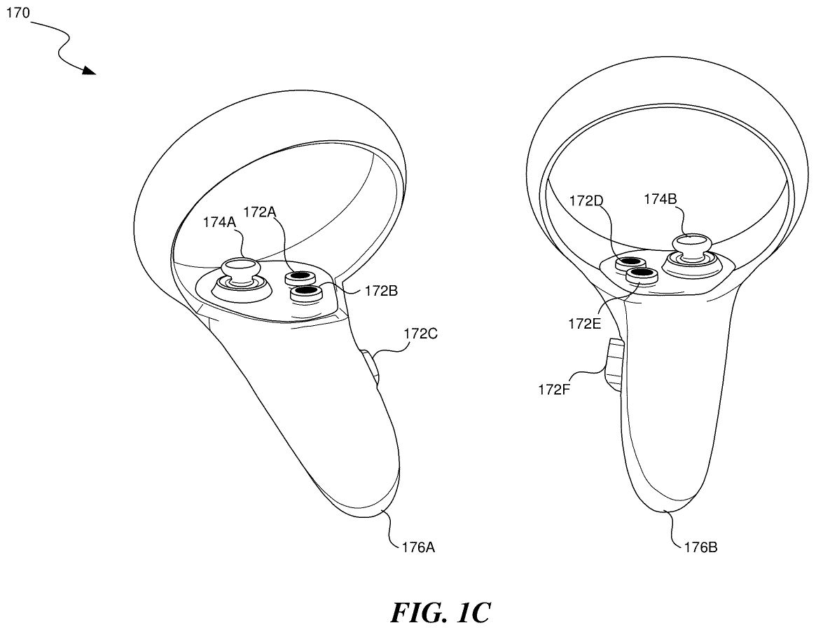

FIG. 1A is a wire diagram of a virtual reality head-mounted display (HMD) 100, in accordance with some embodiments. The HMD 100 includes a front rigid body 105 and a band 110. The front rigid body 105 includes one or more electronic display elements of an electronic display 145, an inertial motion unit (IMU) 115, one or more position sensors 120, locators 125, and one or more compute units 130. The position sensors 120, the IMU 115, and compute units 130 may be internal to the HMD 100 and may not be visible to the user. In various implementations, the IMU 115, position sensors 120, and locators 125 can track movement and location of the HMD 100 in the real world and in an artificial reality environment in three degrees of freedom (3 DoF) or six degrees of freedom (6 DoF). For example, the locators 125 can emit infrared light beams which create light points on real objects around the HMD 100. As another example, the IMU 115 can include e.g., one or more accelerometers, gyroscopes, magnetometers, other non-camera-based position, force, or orientation sensors, or combinations thereof. One or more cameras (not shown) integrated with the HMD 100 can detect the light points. Compute units 130 in the HMD 100 can use the detected light points to extrapolate position and movement of the HMD 100 as well as to identify the shape and position of the real objects surrounding the HMD 100.

The electronic display 145 can be integrated with the front rigid body 105 and can provide image light to a user as dictated by the compute units 130. In various embodiments, the electronic display 145 can be a single electronic display or multiple electronic displays (e.g., a display for each user eye). Examples of the electronic display 145 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 100 can be coupled to a core processing component such as a personal computer (PC) (not shown) and/or one or more external sensors (not shown). The external sensors can monitor the HMD 100 (e.g., via light emitted from the HMD 100) which the PC can use, in combination with output from the IMU 115 and position sensors 120, to determine the location and movement of the HMD 100.

FIG. 1B is a wire diagram of a mixed reality HMD system 150 which includes a mixed reality HMD 152 and a core processing component 154. The mixed reality HMD 152 and the core processing component 154 can communicate via a wireless connection (e.g., a 60 GHz link) as indicated by link 156. In other implementations, the mixed reality system 150 includes a headset only, without an external compute device or includes other wired or wireless connections between the mixed reality HMD 152 and the core processing component 154. The mixed reality HMD 152 includes a pass-through display 158 and a frame 160. The frame 160 can house various electronic components (not shown) such as light projectors (e.g., LASERs, LEDs, etc.), cameras, eye-tracking sensors, MEMS components, networking components, etc.

The projectors can be coupled to the pass-through display 158, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 154 via link 156 to HMD 152. Controllers in the HMD 152 can convert the image data into light pulses from the projectors, which can be transmitted via the optical elements as output light to the user's eye. The output light can mix with light that passes through the display 158, allowing the output light to present virtual objects that appear as if they exist in the real world.

Similarly to the HMD 100, the HMD system 150 can also include motion and position tracking units, cameras, light sources, etc., which allow the HMD system 150 to, e.g., track itself in 3 DoF or 6 DoF, track portions of the user (e.g., hands, feet, head, or other body parts), map virtual objects to appear as stationary as the HMD 152 moves, and have virtual objects react to gestures and other real-world objects.

FIG. 1C illustrates controllers 170 (including controller 176A and 176B), which, in some implementations, a user can hold in one or both hands to interact with an artificial reality environment presented by the HMD 100 and/or HMD 150. The controllers 170 can be in communication with the HMDs, either directly or via an external device (e.g., core processing component 154). The controllers can have their own IMU units, position sensors, and/or can emit further light points. The HMD 100 or 150, external sensors, or sensors in the controllers can track these controller light points to determine the controller positions and/or orientations (e.g., to track the controllers in 3 DoF or 6 DoF). The compute units 130 in the HMD 100 or the core processing component 154 can use this tracking, in combination with IMU and position output, to monitor hand positions and motions of the user. The controllers can also include various buttons (e.g., buttons 172A-F) and/or joysticks (e.g., joysticks 174A-B), which a user can actuate to provide input and interact with objects.

In various implementations, the HMD 100 or 150 can also include additional subsystems, such as an eye tracking unit, an audio system, various network components, etc., to monitor indications of user interactions and intentions. For example, in some implementations, instead of or in addition to controllers, one or more cameras included in the HMD 100 or 150, or from external cameras, can monitor the positions and poses of the user's hands to determine gestures and other hand and body motions. As another example, one or more light sources can illuminate either or both of the user's eyes and the HMD 100 or 150 can use eye-facing cameras to capture a reflection of this light to determine eye position (e.g., based on set of reflections around the user's cornea), modeling the user's eye and determining a gaze direction.

FIG. 2 is a block diagram illustrating components 200 which, in some implementations, can be used in a system employing the disclosed technology. Components 200 can be included in one device of computing system 800 or can be distributed across multiple of the devices of computing system 800. The components 200 include hardware 210, mediator 220, and specialized components 230. As discussed above, a system implementing the disclosed technology can use various hardware including processing units 212, working memory 214, input and output devices 216 (e.g., cameras, displays, IMU units, network connections, etc.), and storage memory 218. In various implementations, storage memory 218 can be one or more of: local devices, interfaces to remote storage devices, or combinations thereof. For example, storage memory 218 can be one or more hard drives or flash drives accessible through a system bus or can be a cloud storage provider (such as in storage 915 or 925) or other network storage accessible via one or more communications networks. In various implementations, components 200 can be implemented in a client computing device such as client computing devices 905 or on a server computing device, such as server computing device 910 or 920.

Mediator 220 can include components which mediate resources between hardware 210 and specialized components 230. For example, mediator 220 can include an operating system, services, drivers, a basic input output system (BIOS), controller circuits, or other hardware or software systems.

Specialized components 230 can include software or hardware configured to perform operations for providing artificial reality (XR) simulation for augment manipulation controls on a two-dimensional (2D) interface. Specialized components 230 can include XR environment simulation module 234, user interface element rendering module 236, movement input receipt module 238, user interface element scaling module 240, and components and APIs which can be used for providing user interfaces, transferring data, and controlling the specialized components, such as interfaces 232. In some implementations, components 200 can be in a computing system that is distributed across multiple computing devices or can be an interface to a server-based application executing one or more of specialized components 230. Although depicted as separate components, specialized components 230 may be logical or other nonphysical differentiations of functions and/or may be submodules or code-blocks of one or more applications.

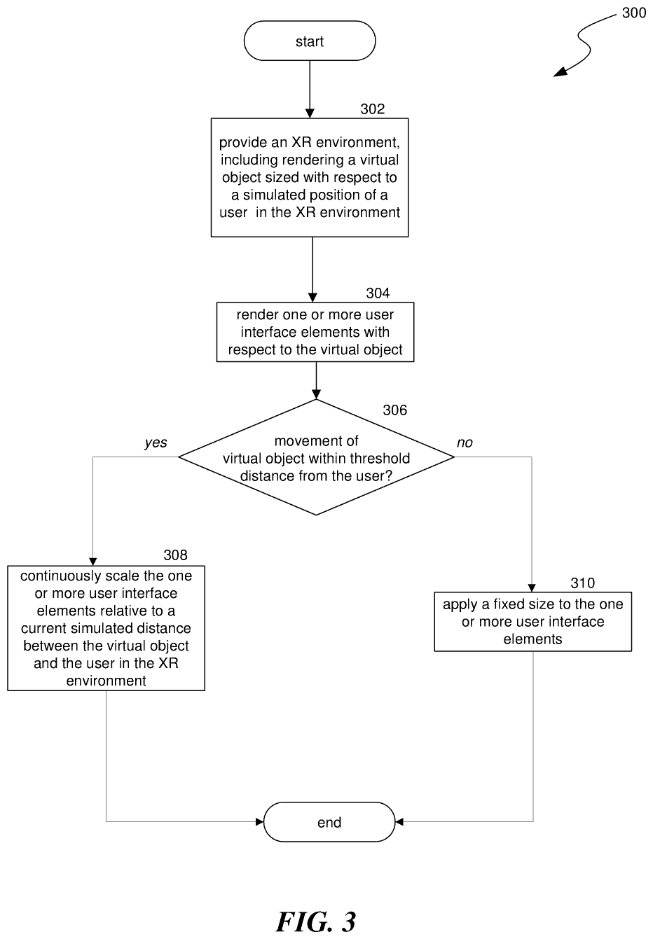

XR environment simulation module 234 can simulate an XR environment on a 2D interface. XR environment simulation module 234 can simulate the XR environment, which would otherwise be rendered on a 3D interface, onto the 2D interface by, for example, flatting the XR environment into two dimensions, e.g., by removing a depth dimension from the rendering data. The XR environment can be rendered on any suitable 2D interface, such as, for example, a computer, a television, a mobile phone, a tablet, etc., which can be accessed by an end user and/or a developer of the XR environment to create and/or manipulate the XR environment. XR environment simulation module 234 can render a virtual object, sized with respect to a simulated position of a user of the 2D interface, in the XR environment. In other words, XR environment simulation module 234 can render the virtual object at a size relative to its position with respect to the user in the XR environment (e.g., with respect to a virtual camera position having the view displayed to the user, as if the camera and the virtual object were within three dimensions). Further details regarding simulating an XR environment on a 2D interface are described herein with respect to block 302 of FIG. 3.

User interface element rendering module 236 can render one or more user interface elements with respect to the virtual object, rendered by XR environment simulation module 234, on the 2D interface. In some cases, the user interface element rendering module 236 can render one or more user interface elements with respect to the virtual object on a 3D interface. In some implementations, the user interface elements can provide information and/or controls relative to the virtual object. For example, the user interface elements can include a bounding box in which the 3D model for the virtual object is located (or a volume of the augment occupied by the virtual object), virtual buttons corresponding to actions with respect to the virtual objects, controls for modifying the virtual object (e.g., deleting the virtual object; changing size, shape, or color of the virtual object; replacing the virtual object; moving the virtual object; scaling the virtual object; etc.), and/or the like. In some implementations, the user of the 2D interface can select such controls to manipulate the virtual object in the XR environment. Further details regarding rendering user interface elements with respect to a virtual object are described herein with respect to block 304 of FIG. 3.

Movement input receipt module 238 can receive input corresponding to simulated movement of either A) the simulated position of the user in the XR environment, or B) the virtual object in the XR environment. In some implementations, a simulated position of the user in the XR environment can be a camera position (i.e., a position in which a view of the XR environment is rendered on the 2D interface). In some implementations, movement input receipt module 238 can receive the input corresponding to simulated movement of the virtual camera or virtual object in the XR environment via one or more controls (e.g., user interface elements) rendered by user interface element rendering module 236. Movement input receipt module 238 can receive the input via, for example, input/output devices 216, which can include, for example, a mouse, a keyboard, a touchpad, a touchscreen, etc. Movement input receipt module 238 can further determine, from the received input, whether the simulated movement of the virtual object places the virtual object within a threshold distance of the position of the user in the XR environment. In some implementations, movement input receipt module 238 can determine the relative positions of the virtual object and the user by, for example, translating the positions of the virtual object and user, with respect to the 2D interface, into the 3D coordinate system of the XR environment having a depth element, as if the XR environment were rendered on a 3D interface. Movement input receipt module 238 can then compare the distance therebetween to a threshold distance to determine whether the virtual object and the user are within the threshold distance. Further details regarding receiving input corresponding to simulated movement of a virtual object in an XR environment, and determining whether the simulated movement is within a threshold distance from a user of a 2D interface, are described herein with respect to block 306 of FIG. 3.

When movement input receipt module 238 determines that the virtual object is within the threshold distance of the user, user interface element scaling module 240 can continuously scale the one or more user interface elements, rendered by user interface element rendering module 236, on the 2D interface and while the virtual object remains within the threshold distance, relative to a current simulated distance between the virtual object and the user in the XR environment. For example, when the virtual object is within the threshold distance of the user in the XR environment, user interface element scaling module 240 can make the user interface elements bigger as the virtual object gets closer to the user, or smaller as the virtual object gets farther from the user. Further details regarding continuously scaling user interface elements relative to a current simulated distance between a virtual object and a user in an XR environment, while simulated movement of the virtual object is within a threshold distance from the user, are described herein with respect to block 308 of FIG. 3.

When movement input receipt module 238 determines that the virtual object is not within the threshold distance of the user, user interface element scaling module 240 can apply a fixed size to the one or more user interface elements while the virtual object remains outside the threshold distance of the user. For example, while the virtual object is outside the threshold distance of the user, the size of the one or more user interface elements, as rendered by user interface element rendering module 236, can remain the same, regardless of whether the virtual object is moved closer or farther from the user. Further details regarding applying a fixed size to user interface elements while simulated movement of a virtual object is outside a threshold distance from a user are described herein with respect to block 310 of FIG. 3.

FIG. 3 is a flow diagram illustrating a process 300 used in some implementations for providing artificial reality (XR) augment manipulation controls, either on a two-dimensional (2D) interface or a three-dimensional (3D) interface. In some implementations, process 300 can be performed upon access of an XR environment, such as by the launching of an application on a 2D interface associated with editing or manipulating the XR environment or executing a XR experience on a 3D interface. In some implementations, process 300 can be performed on a developer computing system or end user device to create new or modify existing XR environments on a 2D or 3D interface, which can be executable on an XR interface. In some implementations, process 300 can be performed by one or more other devices in operable communication with the 2D interface or 3D interface, such as separate processing components.

At block 302, process 300 can provide an XR environment on a 3D interface or can simulate an XR environment on a 2D interface. As part of providing the XR environment at block 302, process 300 can render a virtual object in an augment. The virtual object can be sized with respect to a simulated position of a user, of the interface, in the XR environment. For example, on a 2D interface, a virtual camera position can act as a simulated user position, as if the user were in a 3D environment. In some implementations, the simulated position of the user of the 2D interface can be in “camera space,” i.e., as a camera capturing the XR environment (e.g., as incorporated in an XR head-mounted display (HMD), such as HMD 100 of FIG. 1A and/or HMD 152 of FIG. 1B) would move throughout the XR environment and view the XR environment if the XR environment were rendered and viewed on an XR device worn by the user.

An “augment” can include presentation data, context, and logic. An artificial reality system can use augments as the fundamental building block for displaying 2D and 3D content in the artificial reality environment. For example, augments can represent people, places, and things in an artificial reality environment and can respond to a context such as a current display mode, date or time of day, a type of surface the augment is on, a relationship to other augments, etc. A controller in the artificial reality system, sometimes referred to as a “shell,” can control how artificial reality environment information is surfaced to users, what interactions can be performed, and what interactions are provided to applications. Augments can live on “surfaces” with context properties and layouts that cause the augments to be presented or act in different ways. Augments and other objects (real or virtual) can also interact with each other, where these interactions can be mediated by the shell and are controlled by rules in the augments evaluated based on contextual information from the shell.

An augment can be created by requesting the augment from the artificial reality system shell, where the request supplies a manifest specifying initial properties of the augment. The manifest can specify parameters such as an augment title, a type for the augment, display properties (size, orientation, location, eligible location type, etc.) for the augment in different display modes or contexts, context factors the augment needs to be informed of to enable display modes or invoke logic, etc. The artificial reality system can supply the augment as a volume, with the properties specified in the manifest, for the requestor to place in the artificial reality environment and write presentation data into.

Augment “presentation data” can include anything that can be output by the augment, including visual presentation data, auditory presentation data, haptic presentation data, etc. In some implementations, the presentation data is “live” such that it matches external data either by pointing to that external data or being a copy of it that is periodically updated. The presentation data can also be shared, such that a change to the external data by another user or system can be propagated to the output of the augment. For example, an augment can display live services and data while accepting interactions from users or other augments. As a more specific example, a user may select a photo shared on a social media platform to add as presentation data to an augment that is positioned on her wall. The owner of the post may modify the photo and the modified version can be shown in the augment. Additional live social media content related to the photo may also be in the augment presentation data, such as indications of “likes” or comments on the photo. The owner of the photo may also change the access rights, causing the photo to no longer display in the augment.

An augment can track a current context, based on context factors signaled to the augment by the artificial reality system. A context can include a variety of context factors such as a current mode of the artificial reality system (e.g., interactive mode, minimized mode, audio-only mode, etc.), other objects (real or virtual) in the artificial reality environment or within a threshold distance of an augment, characteristics of a current user, social graph elements related to the current user and/or artificial reality environment objects, artificial reality environment conditions (e.g., time, date, lighting, temperature, weather, graphical mapping data), surface properties, movement characteristics of the augment or of other objects, sounds, user commands, etc. As used herein an “object” can be a real or virtual object and can be an inanimate or animate object (e.g., a user). Context factors can be identified by the artificial reality system and signaled to the relevant augments. Some context factors (e.g., the current artificial reality system mode) can be automatically supplied to all augments. Other context factors can be registered to be delivered to certain augments (e.g., at creation time via the manifest or through a subsequent context factor registration call). The augment can have variables that hold context factors for which the augment has logic. All augments can inherit some of these variables from a base augment class, some of these variables can be defined in extensions of the augment class (e.g., for various pre-established augment types), or some of these variables can added to individual augments at augment creation (e.g., with the manifest) or through a later declaration. In some cases, certain context factors can be tracked by the artificial reality system, which augments can check without the artificial reality system having to push the data to individual augments. For example, the artificial reality system may maintain a time/date global variable which augments can access without the artificial reality system constantly pushing the value of that variable to the augment.

The augment's logic (defined declaratively or imperatively) can cause the augment to change its presentation data, properties, or perform other actions in response to context factors. Similarly to the variable holding context factors, the augment's logic can be specified in a base class, in an extension of the base class for augment types, or individually for the augment (e.g., in the manifest). For example, all augments can be defined to have logic to redraw themselves for different display modes, where the augment is provided different sizes or shapes of volumes to write into for the different modes. As a further example, all augments of a “person” type can have logic to provide notifications of posts by that person or incoming messages from that person. As yet another example, a specific augment can be configured with logic that responds to an area_type context factor for which the augment is registered to receive updates, where the augment responds to that context factor having an “outside” value by checking if a time context factor indicates between 6:00 am and 7:00 pm, and if so, switching to a darker display mode.

At block 304, process 300 can render one or more user interface elements with respect to the virtual object. In some implementations, process 300 can render the one or more user interface elements based on a user interaction with the virtual object. The user interaction can include, for example, a point-and-click on a mouse, a touch of the virtual object on a touchscreen, a keyboard selection via arrows and/or an enter key, a point-and-tap on a touchpad, an air tap or other hand gesture, a voice-selection, a gaze-based selection, etc. The user interface elements can include, for example, user menus, buttons, bounding boxes, controls, etc., that are not part of the virtual object itself. In some implementations, at least one of the one or more user interface elements can provide for manipulation of the virtual object by the user of the interface. In some implementations, at least one of the one or more user interface elements can be virtual buttons that can be selected via the 2D interface (e.g., via a mouse, a touchpad, a touchscreen, a keyboard, etc.) or 3D interface (e.g., via a hand gesture, a voice command, a gaze timer, etc.). For example, the one or more user interface elements can include one or more virtual buttons associated with moving the virtual object, resizing the virtual object, scaling the virtual object, deleting the virtual object, or any combination thereof.

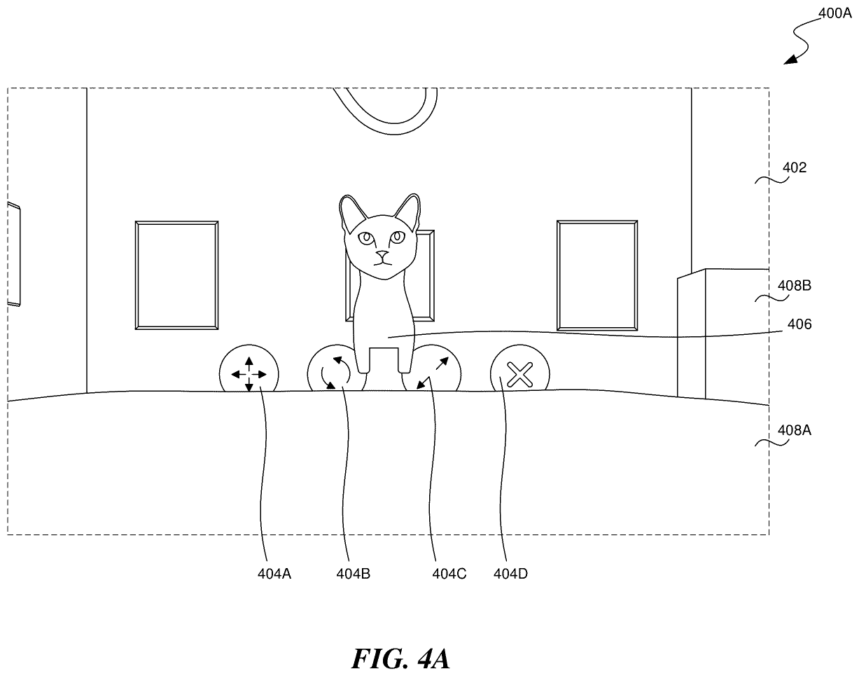

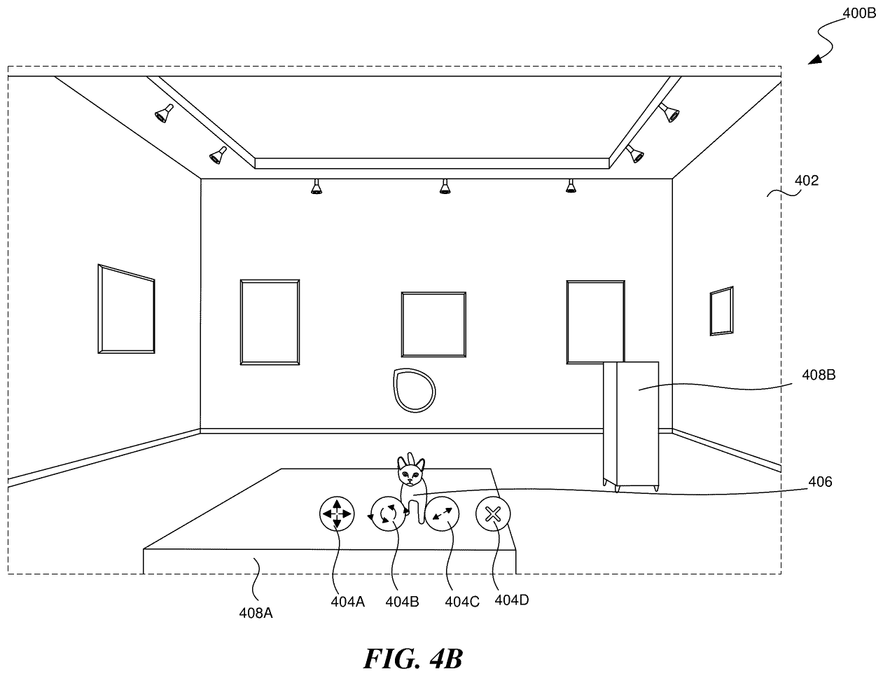

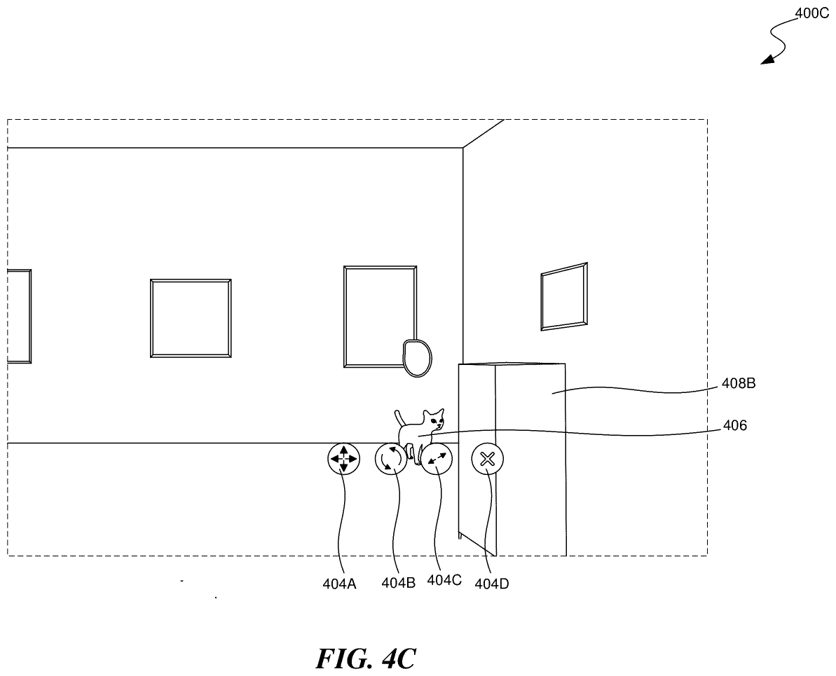

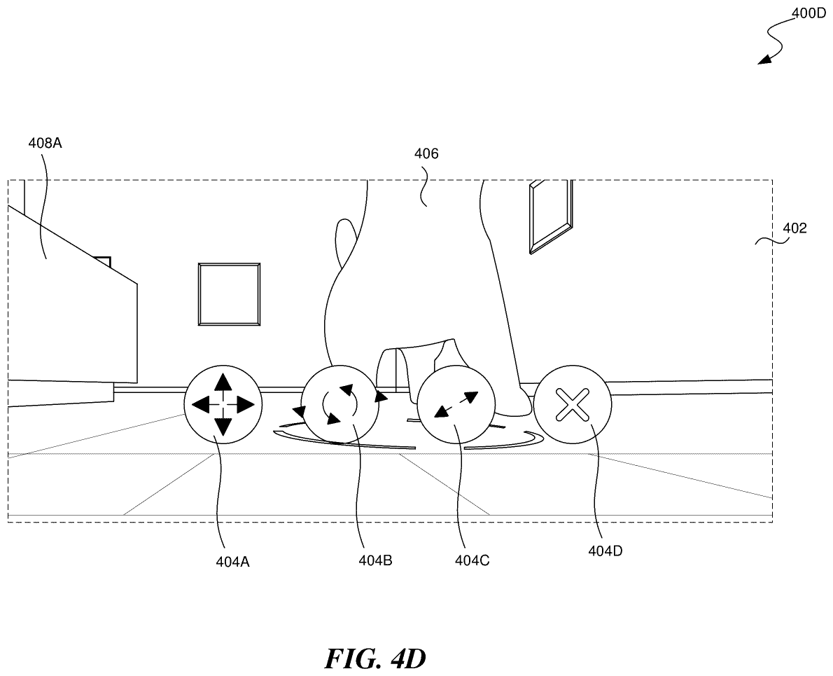

In some implementations, flattening the XR environment onto the 2D interface can cause occlusion by the one or more user interface elements by the virtual objects and/or other virtual objects by default, because depth information is not able to be rendered on the 2D interface, as shown and described with respect to FIG. 4A. Thus, in some implementations, process 300 can render the one or more user interface elements without occlusion by the virtual object, a background of the XR environment flattened onto the 2D interface, other virtual objects rendered on the 2D interface, etc. In other words, in some implementations, the one or more user interface elements can be positioned in front of any other visual elements rendered on the 2D interface, such as by being positioned “closest to the camera” in the view of the XR environment, as shown and described in FIG. 4B herein.

In some implementations, process 300 can render the virtual object before the one or more user interface elements, such that the user interface elements are positioned on top of the virtual object by default. In some implementations, process 300 can render the one or more user interface elements as being at least partially transparent, such that the virtual object (and, in some implementations, the background and/or other virtual objects) are at least partially visible behind the one or more user interface elements. In some implementations, however, it is contemplated that process 300 can render the one or more user interface elements as opaque, such that the virtual object (and, in some implementations, the background and/or other virtual objects) are not visible behind the one or more user interface elements.

In some implementations, however, process 300 can (or has to) render the virtual object after rendering the one or more user interface elements; thus, in some implementations, the virtual object can be rendered over the one or more user interface elements by default. In some implementations, such a rendering order can cause the virtual object to have an overlapping portion with at least a portion of the one or more user interface elements. In such implementations, process 300 can prevent rendering of the virtual object on one or more pixels in the overlapping portion on the 2D interface, such that one or more pixels reflect the one or more user interface elements instead of the virtual object. In some implementations, process 300 can control rendering of the virtual object in such a fashion based on a determination that the one or more pixels have respective alpha values below a transparency threshold (i.e., the one or more pixels are not sufficiently transparent to allow rendering of the portion of the one or more user interface elements to be seen in the overlapping portion therethrough). Thus, in this example, process 300 can entirely block rendering of the virtual object at those pixels, and instead render the pixels corresponding to the one or more user interface elements instead, thus allowing the one or more user interface elements to be seen at those pixels therethrough. In some implementations, if the one or more pixels have respective alpha values above a transparency threshold, process 300 can render the virtual object in the overlapping portion on the two-dimensional interface on those pixels.

At block 306, process 300 can determine whether it has received input corresponding to movement, of the virtual object in the XR environment, to be within a threshold distance from the user. Alternatively or additionally, in some implementations, process 300 can determine whether it has received input corresponding to movement, of the simulated position in the XR environment (corresponding to a position of virtual camera providing a view of the XR environment) within a threshold distance of the virtual object in the XR environment. The input can be, for example, a point-and-click and/or point-and drag operation on a mouse, one or more selections via a keyboard, a touch-and-drag operation on a touchscreen or with a gesture, etc., by the user of the interface with respect to the virtual object. Process 300 can determine whether the movement of the virtual object to be within a threshold distance of the user by, for example, comparing the position of the virtual object, translated into the XR environment, to a position of the user translated into the XR environment (e.g., a camera position within the XR environment for a 2D interface). Process 300 can similarly determine whether the movement of the simulated position of the user in the XR environment is within a threshold distance of the virtual object.

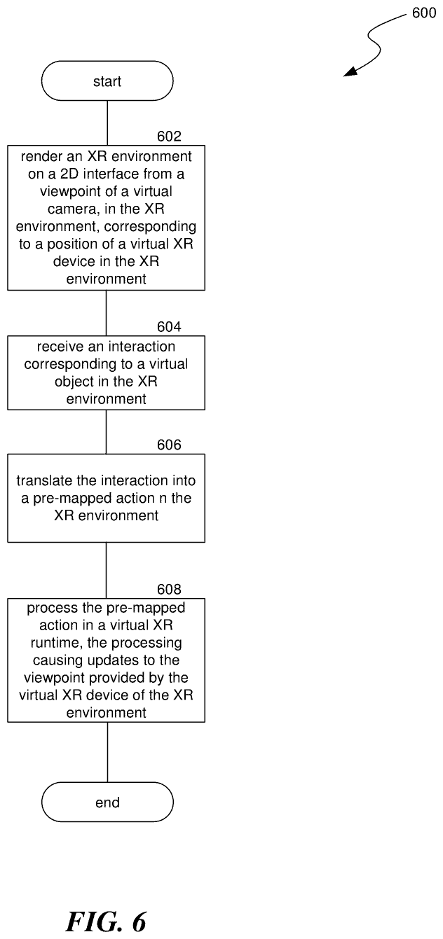

If the positions of the user and the virtual object are within a threshold distance of each other (e.g., 2 m), process 300 can proceed to block 308. At block 308, process 300 can continuously scale the one or more user interface elements, on the 2D interface and while the virtual object is within the threshold distance of the user, relative to a current distance between the virtual object and the user in the XR environment. For example, while within the threshold distance, process 300 can render the one or more user interface elements closer to the user as the user approaches the virtual object, and farther from the user as the user moves away from the virtual object. In other words, when the virtual object is within a threshold distance of the user, process 300 can render the one or more user interface elements such that they change in size according to the distance to the user, similar to how real objects appear when they are moved closer or farther form a user. An exemplary view from an interface of one or user interface elements being scaled while within a threshold distance of the user is shown and described herein with respect to FIG. 6D.

If the distance between the position of the user and the virtual object is outside of the threshold distance (e.g., 2 m), process 300 can proceed to block 310. At block 310, process 300 can apply a fixed size to the one or more user interface elements while the virtual object is outside the threshold distance from the user. In some implementations, the fixed size does not change based on the simulated movement of the virtual object in the XR environment, while the virtual object is outside of the threshold distance from the user. In some implementations, the one or more user interface elements can occupy a same display space on the 2D interface (e.g., a certain percentage of a display screen, a certain number of pixels on the display screen, etc.) while the virtual object remains outside of the threshold distance from the user. For example, while outside of the threshold distance, process 300 can render the one or more user interface elements as the same size, regardless of whether the user comes closer to or farther from the virtual object. In other words, process 300 can render the one or more user interface elements to appear in “camera space” (i.e., locked to the take up the same amount of the visible area) when the virtual object is outside a threshold distance of the user. An exemplary view from an interface of one or more user interface elements being fixed in size while outside of a threshold distance of the user is shown and described herein with respect to FIG. 4C.

Further, regardless of whether process 300 determines that the virtual object is within the threshold distance of the user in the XR environment at block 306, in some implementations, process 300 can continue to scale the virtual object, as rendered on the 2D interface, relative to the simulated movement of the virtual object with respect to the user in the XR environment. For example, while within or outside of the threshold distance, process 300 can render the virtual object closer to the user as the user moves the virtual object closer, and farther from the user as the virtual object moves away from the user. In other words, in some implementations, process 300 can render the virtual object to appear in “world space” (i.e., locked to the XR environment) regardless of whether the virtual object is less than or exceeds a threshold distance from the user.

Although illustrated as being performed as one iteration, it is contemplated that blocks 306 and 308 and/or blocks 306 and 310 can be performed continuously and/or iteratively as the virtual object is moved to different locations within the XR environment, i.e., as the distance between the virtual object and the user is changed. For example, a user can be within a threshold distance of the virtual object, causing the one or more user interface elements to be scaled according to their relative distance. The user can then move the virtual object and have it remain outside the threshold distance of the user, causing process 300 to apply a fixed size to the one or more user interface elements regardless of their relative distance (unless or until the virtual object moves within the threshold distance). Conversely, a virtual object can be outside a threshold distance of the user, causing the one or more user interface elements to have a fixed size regardless of their relative distance, unless or until the virtual object moves within the threshold distance. When the virtual object is moved within the threshold distance of the user, process 300 can scale the one or more user interface elements according to their relative distance (unless or until the virtual object moves back outside the threshold distance).

In some implementations, it is contemplated that blocks 306 and 308 and/or blocks 306 and 310 can be continued to be performed iteratively as the one or more user interface elements are rendered with respect to the virtual object. In some implementations, process 300 can end when the one or more user interface elements are no longer rendered with respect to the virtual object. In some implementations, the user can terminate rendering of the one or more user interface elements by, for example, unselecting the virtual object (e.g., clicking again on the selected virtual object), selecting a different virtual object, deleting the virtual object, etc. In some implementations, process 300 can terminate rendering of the one or more user interface elements based on, for example, termination of an application for rendering and manipulating the XR environment on the interface, and/or by powering off or otherwise disabling the interface. In some implementations, it is contemplated that an XR environment created and/or modified via augment manipulations provided by process 300 can be published for access, use, and/or implementation on 2D and/or 3D interfaces.

FIG. 4A is a conceptual diagram illustrating an example view 400A on a two-dimensional (2D) interface of an artificial reality (XR) environment 402 flattened onto the 2D interface with occlusion of user interface elements 404A-D associated with a virtual object 406 (e.g., a cat). XR environment 402 can include virtual object 406, as well as other virtual objects 408A-B (e.g., pedestals). User interface elements 404A-D can be displayed in association with virtual object 406 (e.g., based on a user selection of virtual object 406, based on a default setting or selection, etc.), and can include augment manipulation controls in some implementations. For example, user interface element 404A can be selected to move virtual object 406; user interface element 404B can be selected to rotate virtual object 406; user interface element 404C can be selected to resize virtual object 406; and user interface element 404D can be selected to delete virtual object 406. Although described herein as user interface elements 404A-D having particular functions and/or controls, it is contemplated that user interface elements 404A-D can provide any alternative functions and/or controls, such as those described elsewhere herein or commonly used in XR systems.

When XR environment 402 is flattened to be displayed on the 2D interface, depth data associated with 3D rendering can be lost. Thus, without depth data, the 2D interface may not know where to place user interface elements 404A-D in XR environment 402, e.g., with respect to virtual object 406 and/or virtual objects 408A-B. For example, in example view 400A, user interface elements 404A-D are occluded by virtual object 406, as well as virtual object 408A. Some implementations of the present technology address this problem and others by providing XR simulation for augment manipulation control (e.g., via user interface elements 404A-D) in XR environment 402, as described further herein, and as illustrated in exemplary FIGS. 4B-4D described below.

FIG. 4B is a conceptual diagram illustrating an example view 400B on a two-dimensional (2D) interface of an artificial reality (XR) environment 402 flattened onto the two-dimensional interface without occlusion of user interface elements 404A-D associated with a virtual object 406 (e.g., a cat). Some implementations can place user interface elements 404A-D in the front of example view 400B (e.g., in front of virtual objects 406 and 408A), relative to a physical or virtual camera that would be capturing example view 400B in XR environment 402. Thus, user interface elements 404A-D are no longer occluded by virtual objects 406 and 408A as in example view 400A of FIG. 4A, and instead appear in front of virtual objects 406 and 408A. Thus, user interface elements 404A-D can be fully viewed and interacted with by a user of the 2D interface. Further, the user of the 2D interface can ascertain that, when rendered on an XR interface, the XR environment includes user interface elements 404A-D and virtual objects 406, 408A-B at various depths with respect to each other.

FIG. 4C is a conceptual diagram illustrating an example view 4000 on an interface of an artificial reality (XR) environment 402, where the user interface elements 404A-D remain fixed in size. In some implementations, in example view 400B of FIG. 4B, virtual object 406 can be greater than a threshold distance from a position of the user of the 2D interface in XR environment 402 (e.g., a camera position in XR environment 402). Thus, user interface elements 404A-D can be rendered with a particular fixed size. In some implementations, from example view 400B of FIG. 4B, the user of the interface can select user interface element 404A (e.g., via a click option or air tap), then can drag virtual object 406 to another location in XR environment 402, as shown in example view 4000 of FIG. 4C. Virtual object 406 can be moved to an even farther distance with respect to the position of the user in the XR environment, which can also be outside the threshold distance of the position of the user in the XR environment. However, user interface elements 404A-D can remain fixed in size between example view 400B of FIG. 4B and example view 4000 of FIG. 4C.

Further, user interface elements 404A-D can continue to not be occluded by virtual object 406 or virtual object 408B, despite being moved to overlap with virtual object 408B. It is contemplated that user interface elements 404A-D can continue to be rendered on top of virtual object 408B, even if virtual object 406 is moved behind virtual object 408B. For example, the user can use the interface to select user interface element 404A to move virtual object 406 behind virtual object 408B (e.g., such that virtual object 406 is occluded by virtual object 408B), but user interface elements 404A-D can continue to be rendered on top of virtual object 406 and virtual object 408B.

FIG. 4D is a conceptual diagram illustrating an example view 400D on an interface of an artificial reality (XR) environment 402, where the user interface elements 404A-D are scaled according to a position of a user of the interface with respect to the virtual object 406. For example, from example view 4000 of FIG. 4C, the user of the 2D interface can select user interface element 404A to move virtual object 406 closer and within a threshold distance of the simulated position of the user in XR environment 402. While within the threshold distance of the user, user interface elements 404A-D can be scaled according to the relative distance between virtual object 406 and the user, i.e., while virtual object 406 is and remains within the threshold distance, user interface elements 404A-D can be made bigger or smaller accordingly (i.e., can appear world-locked instead of camera-locked). In some implementations, however, when virtual object 406 is at the threshold distance from the user, user interface elements 404A-D can have the fixed size reflected in example view 400B of FIG. 4B and example view 4000 of FIG. 4C, and cannot become smaller than the fixed size within the threshold distance.

Aspects of the present disclosure are directed to simulation of an artificial reality (XR) environment on a two-dimensional (2D) interface. Some implementations can simulate a three-dimensional (3D) XR experience on the 2D interface (such as a laptop, mobile phone, tablet, etc.), by placing a virtual XR head-mounted display (HMD) into the XR environment and providing feeds of the field-of view of the virtual XR HMD to the 2D interface. A user of the 2D interface can provide input events to interact with virtual objects in the XR environment (e.g., through a mouse, keyboard, touchpad, etc.) that can be translated into events recognizable by the virtual XR HMD (e.g., head motions, gestures, voice controls, etc.). The translated input event can cause modifications to the XR environment, such as a change in viewpoint, moving about the XR environment, editing the XR environment, etc.

As used herein, an “XR interface,” “XR device,” or “3D interface” can be a device capable of displaying a fully immersive XR environment, such as a head-mounted display within an XR system. In some implementations, the XR system can include devices and components other than the XR interface to support the XR experience, such as processing components, input/output devices (e.g., controllers), etc. Such components are described further herein with respect to FIGS. 1A-1C.

A “2D interface” can be an application or device that can render an XR environment on a 2D surface. For example, a 2D interface can be a computer screen, television display, mobile device (e.g., cellular phone), mobile application, web browser, etc. In some implementations, the 2D interface can be part of a 2D system including other devices and components, such as processing components, input/output devices, etc.

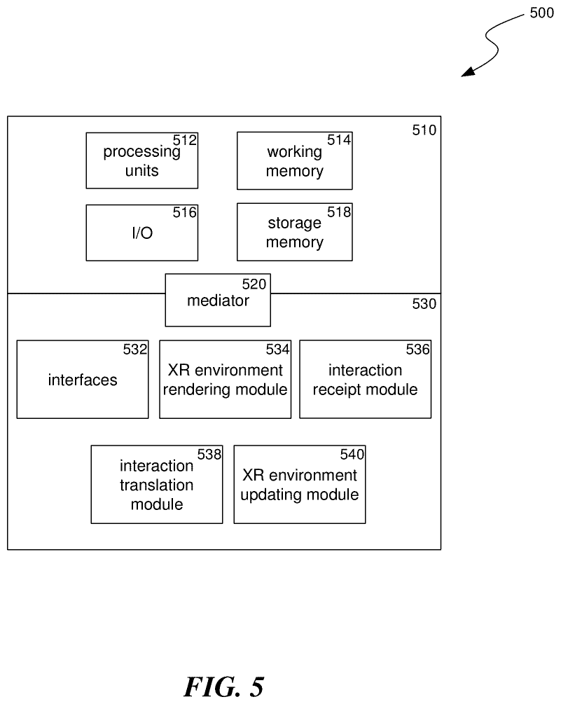

FIG. 5 is a block diagram illustrating components 500 which, in some implementations, can be used in a system employing the disclosed technology. Components 500 can be included in one device of computing system 800 or can be distributed across multiple of the devices of computing system 800. The components 500 include hardware 510, mediator 520, and specialized components 530. As discussed above, a system implementing the disclosed technology can use various hardware including processing units 512, working memory 514, input and output devices 516 (e.g., cameras, displays, IMU units, network connections, etc.), and storage memory 518. In various implementations, storage memory 518 can be one or more of: local devices, interfaces to remote storage devices, or combinations thereof. For example, storage memory 518 can be one or more hard drives or flash drives accessible through a system bus or can be a cloud storage provider (such as in storage 915 or 925) or other network storage accessible via one or more communications networks. In various implementations, components 500 can be implemented in a client computing device such as client computing devices 905 or on a server computing device, such as server computing device 910 or 920.

Mediator 520 can include components which mediate resources between hardware 510 and specialized components 530. For example, mediator 520 can include an operating system, services, drivers, a basic input output system (BIOS), controller circuits, or other hardware or software systems.

Specialized components 530 can include software or hardware configured to perform operations for simulating an artificial reality (XR) environment on a two-dimensional (2D) interface. Specialized components 530 can include XR environment rendering module 534, interaction receipt module 536, interaction translation module 538, XR environment updating module 540, and components and APIs which can be used for providing user interfaces, transferring data, and controlling the specialized components, such as interfaces 532. In some implementations, components 500 can be in a computing system that is distributed across multiple computing devices or can be an interface to a server-based application executing one or more of specialized components 530. Although depicted as separate components, specialized components 530 may be logical or other nonphysical differentiations of functions and/or may be submodules or code-blocks of one or more applications.

XR environment rendering module 534 can render the XR environment on the 2D interface from a viewpoint of a virtual camera, in the XR environment. In some implementations, XR environment rendering module 534 can receive rendering data for the XR environment in three dimensions (e.g., as if it were being provided to an XR device, and/or if it is being provided from an XR device), then flatten the rendering data by removing depth information to render the XR environment on the 2D interface. XR environment rendering module 534 can render the XR environment from a simulated three-dimensional position of a virtual camera in the XR environment, and provide 2D views of the XR environment from the perspective of the simulated position of the virtual camera. In some implementations, the viewpoint of the virtual camera can be mapped a position and orientation of a virtual XR device, such as a virtual XR head-mounted display (HMD), in the XR environment. In some implementations, the virtual XR device can be controllable via interactions received by interaction receipt module 536 and translated by interaction translation module 538. In some implementations, a virtual XR runtime can be provided for the virtual XR device, which can execute XR device system processes and applications as described further herein.

In some implementations, the XR environment can be a fully computer-generated, synthetic environment, such as in virtual reality (VR). In some implementations, the XR environment can include virtual objects overlaid on a view of a real-world environment previously captured by an XR device, such as in mixed reality (MR). In some implementations, the real-world environment can be an environment surrounding the user of the 2D interface (e.g., the user's home environment), while in other implementations, the real-world environment can be a remote environment (e.g., a far away country, a museum, an amusement park, etc., which would be infeasible to move the HMD into to test XR applications in various environments).

XR environment rendering module 534 can render the XR environment with virtual objects, such as visual virtual objects, audio virtual object, haptics virtual objects, etc., which can be static or dynamic in the XR environment. In some implementations, the virtual objects can include user interface elements corresponding to other virtual objects, such as manipulation controls for particular virtual objects (e.g., virtual buttons corresponding to creation commands, editing commands, deletion commands, etc.). In some implementations, one or more of the virtual objects can be labeled objects in the XR environment, i.e., known, identified virtual objects having an identified type (e.g., a desk, a wall, a ceiling, a floor, a doorway, etc.), a known position, and/or a known orientation, that can provide context to the XR environment. In some implementations. XR environment rendering module 534 can use the labeled objects as reference points for positioning other virtual objects (e.g., anchor points), based on the known characteristics of the labeled objects. Further details regarding rendering an XR environment on a 2D interface are described herein with respect to block 602 of FIG. 6.

Interaction receipt module 536 can receive an interaction corresponding to a virtual object rendered by XR environment rendering module 534 in the XR environment. Interaction receipt module 536 can receive the interaction via an input device integral with or otherwise in operable communication with a 2D interface. The input device can be included in, for example, input/output devices 516, which can include a mouse, a touchpad, a keyboard, a microphone, a touchscreen, and/or any other input device commonly associated with a 2D interface. For example, interaction receipt module 536 can receive a point-and click operation via a mouse, a hover operation with a cursor associated with mouse or trackpad movement, a touch operation via a touchscreen, etc. Further details regarding receiving an interaction corresponding to a virtual object in an XR environment are described herein with respect to block 604 of FIG. 6.

Interaction translation module 538 can translate the interaction received by interaction receipt module 536 corresponding to the virtual object into a pre-mapped action with respect to the virtual object. In some implementations, the pre-mapped action can be an action capturable by an XR device in the XR environment, such as a hand gesture, a head gesture, an eye movement, a body movement, an audible announcement, etc., via one or more cameras, microphones, sensors of an inertial measurement unit (IMU), electromyography (EMG) sensors, etc. For example, a point-and-click operation via a mouse on a virtual object in the XR environment, rendered on the 2D interface, can be translated by interaction translation module 538 into an “air tap” hand gesture at the three-dimensional location of the virtual object in the XR environment. In some implementations in which XR environment rendering module 534 is rendering the XR environment based on data streamed from an XR device, interaction translation module 538 can provide the translated interaction to the XR device, which can implement the translated three-dimensional action with respect to the virtual object in the XR environment. In some cases, the user of the 2D interface can select one of multiple possible mappings to translate an input into. For example, a user can select an option for a first mouse click to be translated to an air tap selection action at the click location, a second mouse click to be translated to a pinch gesture at the click location, a third mouse click to be translated to an eye gaze timer input at the click location, a first mouse swipe to be translated to a ray cast in the artificial reality environment, and a second mouse swipe to be translated to an hand movement in the artificial reality environment. Further details regarding translating an interaction into a pre-mapped action (or one or multiple pre-mapped actions), which can corresponding to a virtual object in an XR environment, are described herein with respect to block 606 of FIG. 6.

XR environment updating module 540 can process the pre-mapped action, translated by interaction translation module 538, in the virtual XR runtime. XR environment updating module 540 can further cause updates to the viewpoint provided by the virtual XR device of the XR environment. In some implementations, the pre-mapped action can be relative to the virtual XR device in the XR environment, e.g., a gesture made relative to the virtual XR device, a movement causing the virtual XR device to change location, an eye gaze causing the virtual XR device to change focus, etc. In some implementations in which interaction translation module 538 provides the translated interaction to a real-world XR device, which in turn implements the pre-mapped action, XR environment updating module 540 can receive updated rendering data for the XR environment from the XR device and render the updated XR environment accordingly. However, in some implementations, it is contemplated that XR environment updating module 540 itself can both implement and render the pre-mapped action with respect to the virtual object in the XR environment. For example, interaction translation module 538 can translate a cursor hover over a virtual object on the 2D interface as an eye dwell on the virtual object on a 3D interface, which can cause display of a menu relative to the virtual object when captured by an XR device. Thus, based on the translated eye dwell action, XR environment updating module 540 can update the XR environment to display the menu of options with respect to the virtual object. Further details regarding updating an XR environment based on a pre-mapped action corresponding to a virtual object are described herein with respect to block 608 of FIG. 6.

Those skilled in the art will appreciate that the components and flow diagram blocks illustrated herein, may be altered in a variety of ways. For example, the order of the logic may be rearranged, substeps may be performed in parallel, illustrated logic may be omitted, other logic may be included, etc.

FIG. 6 is a flow diagram illustrating a process 600 used in some implementations for simulating an artificial reality (XR) environment on a two-dimensional (2D) interface. In some implementations, process 600 can be performed upon access of an XR environment on an 2D interface, such as by the launching of an application on the 2D interface associated with displaying, simulating, editing and/or manipulating the XR environment. In some implementations, process 600 can be performed upon selection of a particular XR experience from a menu or list of XR experiences capable of being rendered on the 2D interface. In some implementations, process 600 can be performed on a developer computing system or end user device to create new or modify existing XR environments on a 2D interface, to preview edits to an XR environment on a 2D interface, and/or to execute an XR environment on a 2D interface. In some implementations, process 600 can be performed by one or more other devices in operable communication with the 2D interface, such as separate processing components.

At block 602, process 600 can render the XR environment on the 2D interface from a viewpoint of a virtual camera, in the XR environment, corresponding to a position of a virtual XR device in the XR environment. In some implementations, the virtual XR device can be a virtual XR head-mounted display (HMD). In such implementations, the virtual camera can be considered the point from which a user of the 2D interface would view the XR environment based on, for example, his head position, his head orientation, his eye gaze, etc., if the user were virtually wearing the XR HMD in the XR environment. In some implementations, the virtual XR HMD can have the same capabilities in the XR environment as a physical XR HMD would have, had the user accessed the XR environment from a physical XR HMD. For example, an XR runtime, that artificial reality device 100 of FIG. 1A and/or artificial reality device 152 of FIG. 1B would provide, can execute on the 2D interface, and running applications and system features for the virtual artificial reality device, receive inputs from the virtual artificial reality device, render outputs as the real artificial reality device would, etc. In other words, process 600 can provide a virtual XR runtime, for the virtual XR device, that can execute XR device system processes and applications.

In some implementations, process 600 can render the XR environment with virtual objects that are not visual virtual objects, such as audio virtual objects, haptics virtual objects, etc. In some implementations, the non-visual virtual objects can be associated with visual virtual objects (e.g., a virtual cat meowing, or purring causing a vibration). However, in some implementations, the non-visual virtual objects do not have to be associated with visual virtual objects. For example, different types of music can be played in different locations in the XR environment. In some implementations, process 600 can render the XR environment with spatial audio, such that audio virtual objects positioned farther from the simulated position of the virtual camera are heard with lower volume on the 2D interface relative to audio virtual objects positioned closer to the simulated position of the virtual camera.

In some implementations, process 600 can render the XR environment by, for example, loading one or more virtual objects within the XR environment. In some implementations, the one or more virtual objects can include one or more labeled objects. The labeled objects can have respective metadata defining rendering of the labeled objects in the XR environment. In some implementations, the labeled objects can be planes in the XR environment, such a wall, a ceiling, a floor, a ground, a table, a countertop, etc. In some implementations, the metadata can include a semantic label for the object, e.g., “wall,” “ceiling,” “floor,” etc. In some implementations, the metadata can include position data for the object, such as where the object is located in the XR environment, its location relative to other virtual objects, etc. In some implementations, the metadata can include orientation data for the object, e.g., a facing direction of the object, an angle of the object, planes normal to the object, etc.).

In some implementations, the XR environment can be a mixed reality (MR) or augmented reality (AR) environment in which process 600 overlays the one or more virtual objects onto a rendered view of a real-world environment. In some implementations, the 2D interface can be located remotely from the real-world environment shown on the rendered view, e.g., can be different than the real-world environment surrounding the user of the 2D interface. In some implementations, the 2D interface can be co-located with the real-world environment. For example, an XR device in operable communication with the 2D interface can capture, either previously or in real-time, the rendered view of the real-world environment surrounding the user onto which the virtual objects are overlaid.

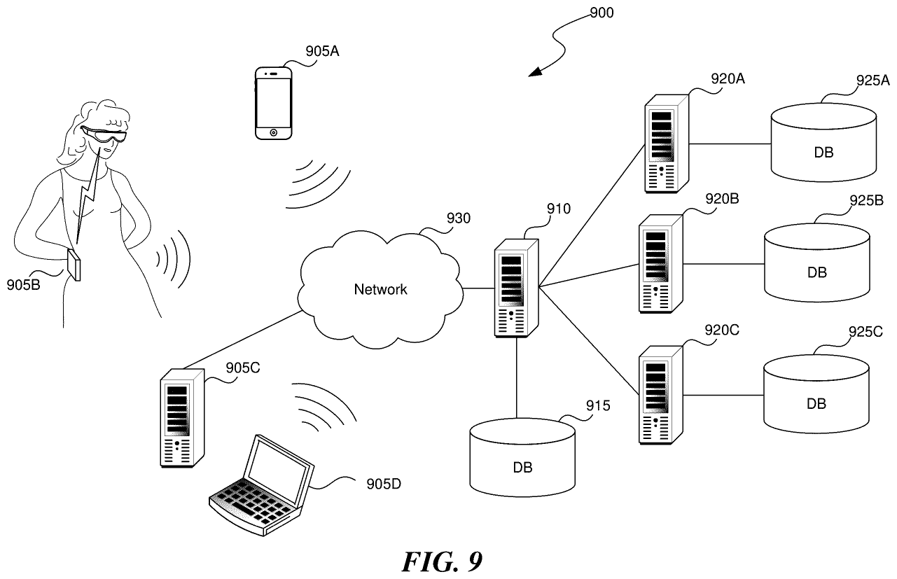

As discussed above, process 600 can respond to inputs and render the XR environment on the 2D interface by executing a virtual machine version of the artificial reality device to run system processes and XR applications as if they were being executed on a real-world artificial reality device. However, in some implementations, process 600 can execute the virtual XR runtime and/or render the XR environment on the 2D interface based on a data stream received from a real-world XR device in operable communication with the 2D interface. For example, the 2D interface can have a wired or wireless connection to a physical XR device having access to the XR environment or by translating inputs to the real-world artificial reality device, e.g., over network 930 of FIG. 9, from virtual sensors executed by the 2D interface and put in the synthetic artificial reality environment. The physical XR device can have an application programming interface (API) passing data for rendering of the XR environment to the 2D interface. Thus, in some implementations, process 600 can leverage the hardware and/or software capabilities of the physical XR device in accessing and simulating the XR environment, then can provide rendering data to the 2D interface for the simulated XR environment. In some implementations, process 600 can render the XR environment on the 2D interface, rather than on the XR device, to improve processing speed, latency, and power consumption in rendering the XR environment, i.e., to leverage the lower power display and/or faster display processing speeds of the 2D interface, by eliminating the third dimension.

At block 604, process 600 can receive an interaction corresponding to a virtual object, of the one or more virtual objects, in the XR environment. In some implementations, process 600 can receive the interaction from a user of the 2D interface via an input device in operable communication with the 2D interface. The input device can include, for example, a mouse, a keyboard, a touchpad, a touchscreen, a microphone, etc., integral with or otherwise communicatively coupled to the 2D interface. The user input can be, for example, a point-and-click operation, a hovering operation, a point-and-drag or swipe operation, a highlight-and-enter operation, an audible command, etc., captured by the input device. In some implementations, process 600 can receive an interaction with a labeled object in the XR environment (e.g., corresponding to a wall, floor, ceiling, etc.), and can select to add a new virtual object to the XR environment relative to the labeled object (e.g., placing a virtual painting on the virtual wall).

At block 606, process 600 can translate the interaction corresponding to the virtual object, received via the input device, into a pre-mapped action corresponding to the virtual object in the XR environment. In some implementations, the pre-mapped action can be relative to the virtual camera in the XR environment. For example, in some implementations, the pre-mapped action can correspond to a three-dimensional (3D) action in the XR environment relative to the virtual camera, such as simulated movement of the virtual camera in the XR environment, detection of an action taken in the XR environment by the virtual camera, etc. In some implementations, the pre-mapped actions can be actions detectable by a physical XR HMD, if the user of the 2D interface were instead accessing the XR environment via the physical XR HMD at the simulated position of the virtual camera.

In some implementations, the pre-mapped action can include a hand gesture event in the XR environment. For example, a point-and-click operation on a mouse can be mapped to an air tap gesture at the virtual location where the click is made. In some implementations, the pre-mapped action can be a head movement event in the XR environment. For example, a touch-and-drag operation on a touchscreen can be mapped to a head or eye movement relative to the virtual location where the touch is made. In some implementations, the pre-mapped action can include a navigation event in the XR environment. For example, pressing of an “up” button on a keyboard can be mapped to simulated movement of the virtual camera forward in the XR environment. In some cases, the user of the 2D interface can select one of multiple possible mappings to translate an input into. For example, a user can select an option for a first mouse click to be translated to an air tap selection action at the click location, a second mouse click to be translated to a pinch gesture at the click location, a third mouse click to be translated to an eye gaze timer input at the click location, a first mouse swipe to be translated to a ray cast in the artificial reality environment, and a second mouse swipe to be translated to an hand movement in the artificial reality environment.

At block 608, process 600 can process the pre-mapped action in the virtual XR runtime. In some implementations, the processing can cause updates to the viewpoint, provided by the virtual XR device, of the XR environment. For example, process 600 can edit a virtual object, change the field-of-view shown by the virtual camera in the XR environment, navigate through the XR environment, add a new virtual object, delete a virtual object, etc. In some implementations, based on the pre-mapped action, process 600 can link the virtual object to a labeled object of the one or more labeled objects. In such implementations, process 600 can update the XR environment, based on the pre-mapped action corresponding to the virtual object, by rendering the virtual object relative to the labeled object based on the metadata of the labeled object. For example, process 600 can link a virtual photograph to a labeled virtual wall, and can orient and render the virtual photograph on the virtual wall based on the characteristics of the virtual wall (e.g., its semantic label, its position, its orientation, etc.).

In some implementations, process 600 can render the XR environment at block 602 to include one or more user interface elements corresponding to a virtual object. In some implementations, process 600 can render the one or more user interface elements based on a user interaction with the virtual object. The user interaction can include, for example, a point-and-click on a mouse, a touch of the virtual object on a touchscreen, a keyboard selection via arrows and/or an enter key, a point-and-tap on a touchpad, a voice-selection, a gaze-based selection, etc. The user interface elements can include, for example, user menus, buttons, bounding boxes, controls, etc., that are not part of the virtual object itself. In some implementations, at least one of the one or more user interface elements can provide for manipulation of the virtual object by the user of the 2D interface. For example, the one or more user interface elements can include one or more virtual buttons associated with moving the virtual object, resizing the virtual object, scaling the virtual object, deleting the virtual object, or any combination thereof.

In some implementations, at least one of the one or more user interface elements can be virtual buttons that can be selected via the 2D interface (e.g., via a mouse, a touchpad, a touchscreen, a keyboard, etc.). In some implementations, selection of a user interface element via the 2D interface can be mapped to a corresponding action on a 3D interface (e.g., a hand gesture, a gaze timer, a head movement, etc.). In some implementations, this pre-mapped action can cause the selection of the user interface element. In some implementations, updating the XR environment at block 608 can include manipulating the virtual object in the XR environment based on the selection.

In some implementations, flattening the XR environment onto the 2D interface can cause occlusion of the one or more user interface elements by one or more virtual objects by default, because depth information is not able to be rendered on the 2D interface. Thus, in some implementations, process 600 can render the one or more user interface elements without occlusion by the selected virtual object, a background of the XR environment flattened onto the 2D interface, other virtual objects rendered on the 2D interface, etc. In other words, in some implementations, the one or more user interface elements can be positioned in front of any other visual elements rendered on the 2D interface, such as by being positioned closest to the simulated position of the virtual camera in the view of the XR environment, as shown and described with respect to FIG. 6C herein.

Although illustrated as being performed as one iteration, it is contemplated that blocks 604-608 can be performed iteratively as interactions corresponding to virtual objects are received. In some implementations, process 600 can end when no further interactions are made in the XR environment and/or when rendering of the XR environment is terminated. In some implementations, process 600 can terminate rendering of the XR environment based on, for example, termination of an application for simulating, rendering, or manipulating the XR environment on the 2D interface, and/or by powering off or otherwise disabling the 2D interface. In some implementations, it is contemplated that an XR environment simulated, created, and/or modified via process 600 can be published for access, use, and/or implementation on 2D and/or 3D interfaces, such as XR devices (e.g., XR HMD 100 of FIG. 1A and/or XR HMD 152 of FIG. 1B).

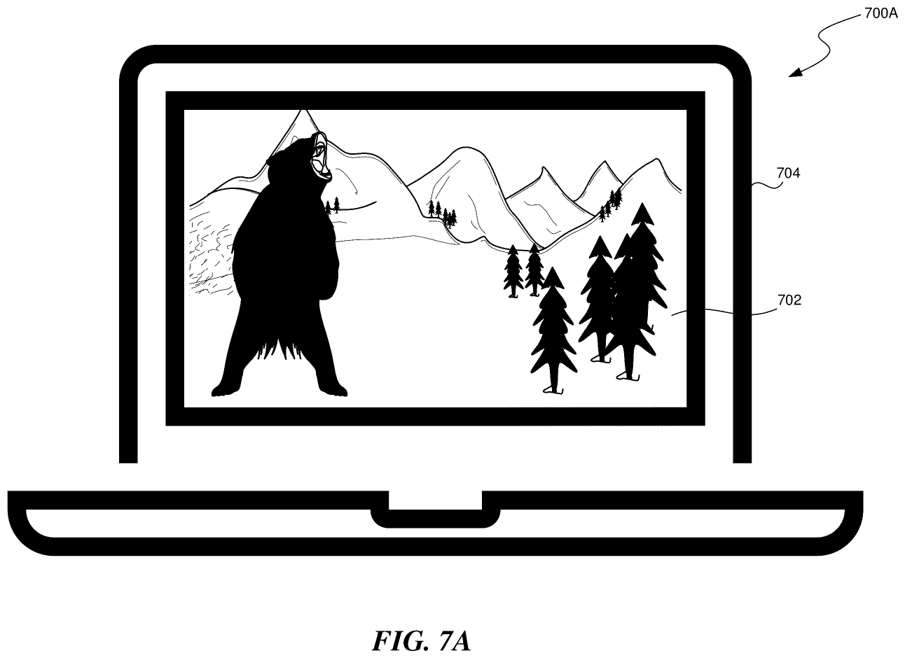

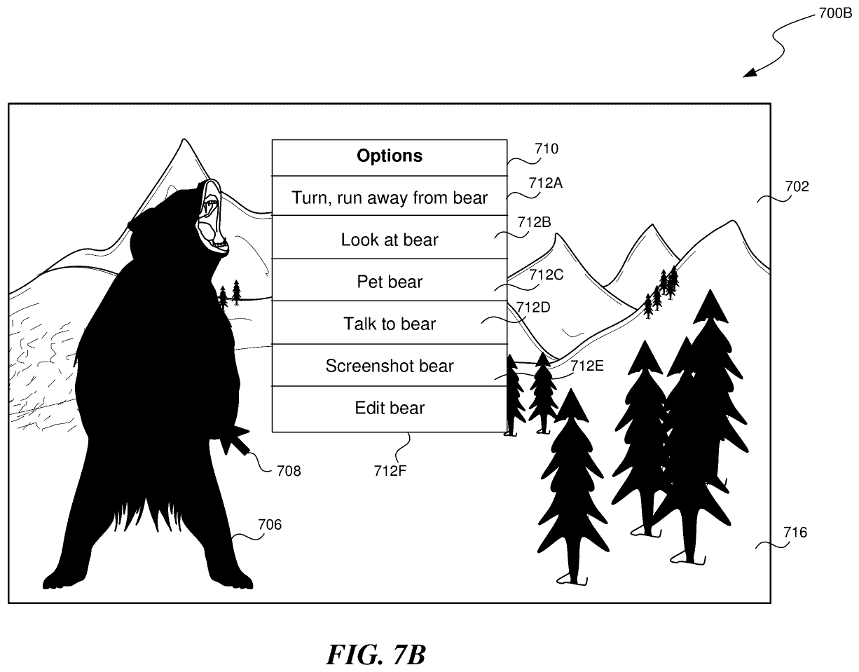

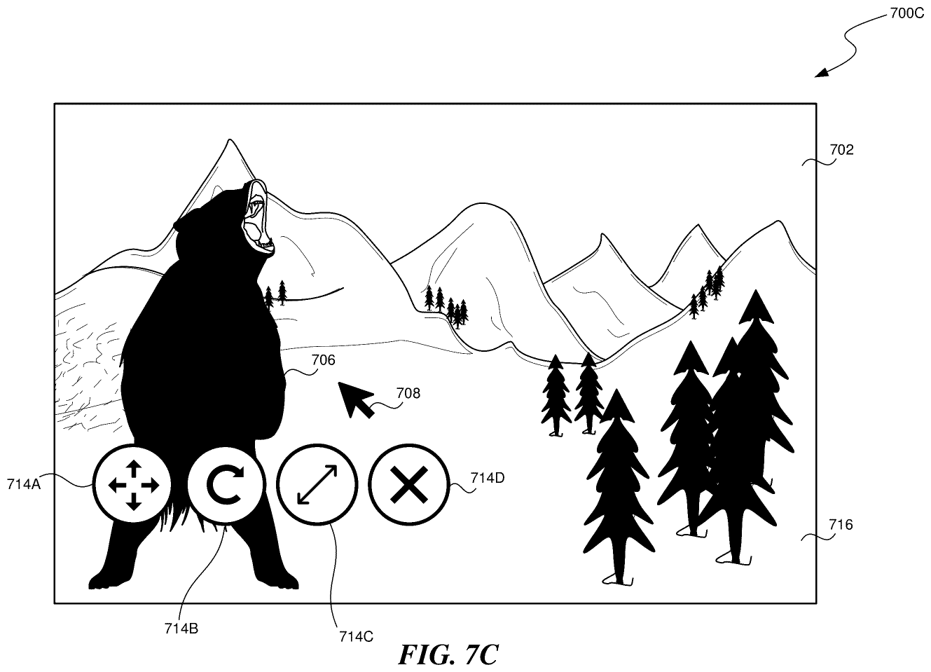

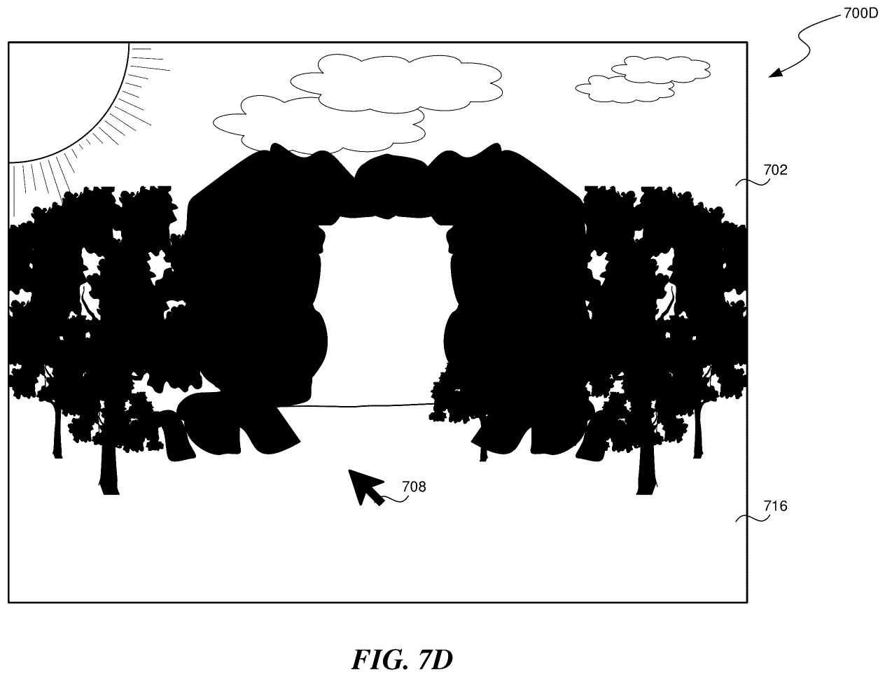

FIG. 7A is a conceptual diagram illustrating an example view 700A of a two-dimensional (2D) interface 704 rendering a simulated artificial reality (XR) environment 702. In some implementations, XR environment 702 can be processed on an XR device (not shown) in operable communication with 2D interface 704. 2D interface 704 can obtain rendering data from the XR device for XR environment 702, flatten the rendering data to two dimensions, then render simulated XR environment 702. In some implementations, 2D interface 704 can independently access, process, and render XR environment 702, without being in operable communication with an XR device. Although illustrated as being a laptop computer, it is contemplated that 2D interface 704 can instead be a mobile phone or other mobile device, tablet, desktop computer, television screen, gaming device, etc. having a display screen capable of 2D rendering.

FIG. 7B is a conceptual diagram illustrating an example view 700B, from a two-dimensional (2D) interface 704, of interaction options 712A-F with respect to a virtual object 706 rendered on the 2D interface 704 in a simulated artificial reality (XR) environment 702. In some implementations, 2D interface 704 can render XR environment 702 from a simulated position of a virtual camera (e.g., as would be included on a virtual XR head-mounted display (HMD)) in XR environment 702. In some implementations, interaction options 712A-F can be system-level options on 2D interface 704, system-level options on the virtual XR HMD, or options available in the particular XR experience loaded in XR environment 702. XR environment 702 can include multiple virtual objects, such as virtual object 706 (e.g., a virtual bear), labeled object 716 (e.g., a ground plane), and other virtual objects shown in example view 700B. In some implementations, 2D interface 704 can render virtual object 706 (e.g., the virtual bear) relative to labeled object 716 (e.g., the ground plane) based on metadata indicating that labeled object 716 is a ground plane, as well as the position and orientation of the ground plane. Thus, in example view 700B, virtual object 706 (e.g., the virtual bear) can be positioned normal to and touching labeled object 716 (e.g., the ground plane).

In some implementations, the user of 2D interface 704 can use an input device (integral with or otherwise in operable communication with 2D interface 704) to point at and select virtual object 706. For example, the user of 2D interface 704 can position cursor 708 over virtual object 706 with a mouse or touchpad, then click or tap to select virtual object 706. Responsive to receiving selection of virtual object 706, 2D interface 704 can present menu 710 of interaction options 712A-F that can be selected to perform pre-mapped actions in XR environment 702. For example, the user of 2D interface 704 can select, with the input device: interaction option 712A to “turn” and “run away” from virtual object 706 (i.e., rotate the virtual camera 180 degrees away from virtual object 706 and move the virtual camera away from virtual object 706 in XR environment 702, simulating turning the body and moving while wearing a virtual XR HMD); interaction option 712B to “look at” virtual object 706 (i.e., turn the focus of the virtual camera toward virtual object 706, simulating head or eye movement captured by a virtual XR HMD); interaction option 712C to “pet” virtual object 706 (i.e., moving the virtual camera toward virtual object 706, simulating a hand gesture toward virtual object 706 as captured by a virtual XR HMD); interaction option 712D to “talk to” virtual object 706 (i.e., simulating audio capture by a microphone of a virtual XR HMD); interaction option 712E to “screenshot” virtual object 706 (i.e., simulating image capture by the virtual camera); and interaction option 712F to edit virtual object 706 (e.g., to display a menu of editing options for manipulating virtual object 706 in XR environment 702). To select one of interaction options 712A-F from menu 710, the user of 2D interface 704 can again use the input device to control cursor 708 and make a selection.

FIG. 7C is a conceptual diagram illustrating an example view 700C, from a two-dimensional (2D) interface 704, of user interface elements 714A-D for manipulating a virtual object 706 rendered on the 2D interface 704 in a simulated artificial reality (XR) environment 702. For example, from example view 700B of FIG. 7B, a user of 2D interface 704 can use cursor 708 to select interaction option 712F to edit virtual object 706. Some implementations can translate selection of interaction option 712F into a finger “air tap” captured by the virtual camera in the simulated location of interaction option 712F. Upon selection of interaction option 712F, 2D interface 704 can render example view 700C of FIG. 7C having user interface elements 714A-D. In another example, 2D interface 704 can display user interface elements 714A-D upon an initial selection of virtual object 706, bypassing menu 710. In still another example, 2D interface 704 can display user interface elements 714A-D based on a default setting or selection when accessing XR environment 702. Some implementations can place user interface elements 714A-D in the front of example view 700C (e.g., in front of virtual object 706 and labeled object 716), relative to the virtual camera that would be capturing example view 700C in XR environment 702. Thus, user interface elements 714A-D are not occluded by virtual object 706 or labeled object 716, and instead appear in front of virtual object 706 and labeled object 716 for access and/or selection via cursor 708.

User interface elements 714A-D can be displayed in association with virtual object 706, and can include virtual object manipulation controls in some implementations. For example, user interface element 714A can be selected to move virtual object 706; user interface element 714B can be selected to rotate virtual object 706; user interface element 714C can be selected to resize virtual object 706; and user interface element 714D can be selected to delete virtual object 706. Although described herein as user interface elements 714A-D having particular functions and/or controls, however, it is contemplated that user interface elements 714A-D can provide any alternative functions and/or controls, such as those described elsewhere herein or commonly used in XR systems. For example, user interface elements 714A-D could alternatively or additionally include options for moving the virtual camera, such as moving the virtual camera to inspect a virtual object, which could position the virtual camera and view direction at a particular location (e.g., placing virtual object 706 closer and at the center of view 700C), such as by a single click on a mouse.

FIG. 7D is a conceptual diagram illustrating an example view 700D, from a two-dimensional (2D) interface 704, of a simulated artificial reality (XR) environment 702, which has been updated based on selection of an interaction option 712A with respect to a virtual object 706 rendered on the 2D interface 704. For example, from example view 700B of FIG. 7B, a user of 2D interface 704 can use cursor 708 to select interaction option 712A to “turn” and “run away” from virtual object 706. Some implementations can translate selection of interaction option 712A into simulated rotation of the virtual camera 180 degrees from virtual object 706, and movement of the virtual camera away from virtual object 706, in XR environment 702. Such a movement of the virtual camera can simulate turning of a user's body away from virtual object 706, and moving quickly away from virtual object 706, while wearing a virtual XR HMD. Thus, 2D interface 704 can render example view 700D showing updated XR environment 702, which can be a view “behind” the simulated position of the virtual camera in view 700B of FIG. 7C and view 700C of FIG. 7C.

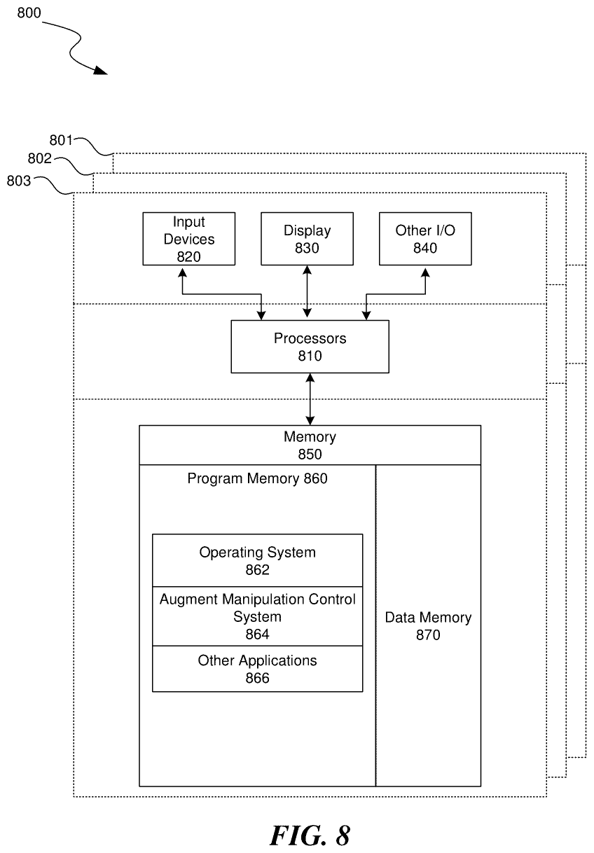

FIG. 8 is a block diagram illustrating an overview of devices on which some implementations of the disclosed technology can operate. The devices can comprise hardware components of a device 800 as shown and described herein. Device 800 can include one or more input devices 820 that provide input to the Processor(s) 810 (e.g., CPU(s), GPU(s), HPU(s), etc.), notifying it of actions. The actions can be mediated by a hardware controller that interprets the signals received from the input device and communicates the information to the processors 810 using a communication protocol. Input devices 820 include, for example, a mouse, a keyboard, a touchscreen, an infrared sensor, a touchpad, a wearable input device, a camera- or image-based input device, a microphone, or other user input devices.

Processors 810 can be a single processing unit or multiple processing units in a device or distributed across multiple devices. Processors 810 can be coupled to other hardware devices, for example, with the use of a bus, such as a PCI bus or SCSI bus. The processors 810 can communicate with a hardware controller for devices, such as for a display 830. Display 830 can be used to display text and graphics. In some implementations, display 830 provides graphical and textual visual feedback to a user. In some implementations, display 830 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 840 can also be coupled to the processor, such as a network card, video card, audio card, USB, firewire or other external device, camera, printer, speakers, CD-ROM drive, DVD drive, disk drive, or Blu-Ray device.

In some implementations, the device 800 also includes a communication device capable of communicating wirelessly or wire-based with a network node. The communication device can communicate with another device or a server through a network using, for example, TCP/IP protocols. Device 800 can utilize the communication device to distribute operations across multiple network devices.

The processors 810 can have access to a memory 850 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 850 can include program memory 860 that stores programs and software, such as an operating system 862, Augment Manipulation Control System 864, and other application programs 866. Memory 850 can also include data memory 870, which can be provided to the program memory 860 or any element of the device 800.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 9 is a block diagram illustrating an overview of an environment 900 in which some implementations of the disclosed technology can operate. Environment 900 can include one or more client computing devices 905A-D, examples of which can include device 800. Client computing devices 905 can operate in a networked environment using logical connections through network 930 to one or more remote computers, such as a server computing device.

In some implementations, server 910 can be an edge server which receives client requests and coordinates fulfillment of those requests through other servers, such as servers 920A-C. Server computing devices 910 and 920 can comprise computing systems, such as device 800. Though each server computing device 910 and 920 is displayed logically as a single server, server computing devices can each be a distributed computing environment encompassing multiple computing devices located at the same or at geographically disparate physical locations. In some implementations, each server 920 corresponds to a group of servers.

Client computing devices 905 and server computing devices 910 and 920 can each act as a server or client to other server/client devices. Server 910 can connect to a database 915. Servers 920A-C can each connect to a corresponding database 925A-C. As discussed above, each server 920 can correspond to a group of servers, and each of these servers can share a database or can have their own database. Databases 915 and 925 can warehouse (e.g., store) information. Though databases 915 and 925 are displayed logically as single units, databases 915 and 925 can each be a distributed computing environment encompassing multiple computing devices, can be located within their corresponding server, or can be located at the same or at geographically disparate physical locations.

Network 930 can be a local area network (LAN) or a wide area network (WAN), but can also be other wired or wireless networks. Network 930 may be the Internet or some other public or private network. Client computing devices 905 can be connected to network 930 through a network interface, such as by wired or wireless communication. While the connections between server 910 and servers 920 are shown as separate connections, these connections can be any kind of local, wide area, wired, or wireless network, including network 930 or a separate public or private network.

In some implementations, servers 910 and 920 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

I/We claim:

1. A method for contextually modifying and rendering user interfaces for virtual object manipulation on a two-dimensional interface, the method comprising:
simulating an artificial reality environment on the two-dimensional interface, wherein simulating the artificial reality environment includes rendering a virtual object on the two-dimensional interface;
rendering one or more user interface elements with respect to the virtual object, at least one of the one or more user interface elements providing for manipulation of the virtual object;
receiving either A) input causing movement of the virtual object, in the artificial reality environment, to be within a threshold distance from a position of a user of the two-dimensional interface in the artificial reality environment, or B) input causing movement of the position of the user, in the artificial reality environment, to be within a threshold distance from the virtual object;
continuously scaling the one or more user interface elements, on the two-dimensional interface and while the virtual object is within the threshold distance from the position of the user, relative to a current distance between the virtual object and the position of the user in the artificial reality environment;
receiving a command causing further movement of either A) the virtual object, in the artificial reality environment, to be outside of the threshold distance from the position of the user, or B) the position of the user, in the artificial reality environment, to be outside of the threshold distance from the virtual object; and
applying a fixed size to the one or more user interface elements while the virtual object is outside the threshold distance from the position of the user.

2. A method for simulating an artificial reality (XR) environment on a two-dimensional interface, the method comprising:
rendering the XR environment on the two-dimensional interface from a viewpoint of a virtual camera, in the XR environment, corresponding to a position of a virtual XR device in the XR environment, wherein the rendering provides a viewpoint of the virtual XR device and a virtual XR runtime is provided, for the virtual XR device, executing XR device system processes and applications;
receiving an interaction corresponding to a virtual object in the XR environment, from a user of the two-dimensional interface via an input device in operable communication with the two-dimensional interface;
translating the interaction corresponding to the virtual object into a pre-mapped action in the XR environment, the pre-mapped action being relative to the virtual camera in the XR environment; and
processing the pre-mapped action in the virtual XR runtime, the processing causing updates to the viewpoint provided by the virtual XR device of the XR environment.
